(19) United States
(12) Patent Application Publication
(10) Pub. No.: US 2018/0038464 A1
(43) Pub. Date: Feb. 8, 2018

(54) HIGH-INERTIA STATOR ASSEMBLY FOR CONTROLLING OPERATION OF A ONE-WAY CLUTCH IN A TORQUE CONVERTER

(71) Applicant: Caterpillar Inc., Peoria, IL (US)

(72) Inventors: Paul D. Cashatt, Edwards, IL (US); Edward De Jesus Rivera, Peoria, IL (US)

(73) Assignee: Caterpillar Inc., Peoria, IL (US)

(21) Appl. No.: 15/225,968

(22) Filed: Aug. 2, 2016

(51) Int. Cl. F16H 41/24; F16H 45/02; F16D 41/066

(52) U.S. Cl. CPC F16H 41/24; F16D 41/066; F16H 45/02; F16H 2041/246

(57) ABSTRACT

A stator assembly for a torque converter having an impeller and a turbine includes a one-way clutch. The one-way clutch includes a plurality of rollers arranged radially in a spaced apart relation to one another. Each of the plurality of rollers is biased into a floating position by a corresponding resilient member. The stator assembly also includes a stator wheel mounted on the one-way clutch. A mass of the stator wheel is selected so as to operatively provide a predetermined amount of delay for engaging or disengaging the one-way clutch.

### TECHNICAL FIELD

The present disclosure relates to a torque converter. More particularly, the present disclosure relates to a high inertia stator assembly for controlling operation of a one-way clutch in a torque converter.

### BACKGROUND

Torque converters are generally used to transmit drive power from a prime mover e.g., an engine or an electric motor to a transmission. Typically, torque converters include an impeller, a turbine, and a stator wheel that is mounted on a one-way clutch interposed between the impeller and the turbine. The stator wheel is held stationary by the one-way clutch during a stall mode or torque multiplication mode while the one-way clutch allows the stator wheel to freewheel during the coupling mode so that fuel efficiency of the prime mover can be increased.

In many cases, a one-way clutch typically consists of multiple rollers in which each roller is being biased into a floating position to allow the stator wheel to freewheel in the coupling mode i.e., when a speed of the turbine nearly approaches that of the impeller, the one-way clutch will release so that the stator wheel can now facilitate the turbine to rotate at a speed nearly equal to that of the impeller. In addition, the rollers of the one-way clutch can also be biased into a sliding position in which the stator wheel is allowed to freewheel at a rotational speed less than a pre-determined value of the rotational speed at which centripetal forces on the rollers become sufficient enough to compress corresponding ones of resilient members and move the rollers into the floating position.

However, during the stall mode or the torque multiplication mode, differences in speed or torque between the impeller and the turbine can tend to cause the stator wheel and the one-way clutch to counter-rotate in relation to the impeller and the turbine. In these modes of operation, the rollers of the one-way clutch are configured to become engaged to maintain a stationary position of the stator wheel.

During operation, the rollers of the one-way clutch are frequently forced to shift from a floating position to an engaged position and vice-versa depending on a relative difference between the rotational speeds of the impeller and the turbine. Moreover, a movement of the rollers between the floating and engaged positions may be rapid enough so as to cause fatigue and/or failure to the rollers over prolonged durations of operation.

Hence, there is a need for a stator wheel that overcomes the aforementioned shortcomings.

### SUMMARY OF THE DISCLOSURE

In an aspect of the present disclosure, a stator assembly for a torque converter having an impeller and a turbine includes a one-way clutch. The one-way clutch includes a plurality of rollers arranged radially in a spaced apart relation to one another. Each of the plurality of rollers is biased into a floating position by a corresponding resilient member. The stator assembly also includes a stator wheel mounted on the one-way clutch. A mass of the stator wheel is selected so as to operatively provide a predetermined amount of delay for engaging or disengaging the one-way clutch.

In another aspect of the present disclosure, a torque converter includes an impeller, a turbine operatively coupled to the impeller, and a stator wheel mounted on a one-way clutch and interposed between the impeller and the turbine. The one-way clutch has a plurality of rollers arranged radially in a spaced apart relation to one another in which each of the plurality of rollers is biased into a floating position by a corresponding resilient member. A mass of the stator wheel is selected to operatively provide a predetermined amount of delay for engaging or disengaging the one-way clutch.

Other features and aspects of this disclosure will be apparent from the following description and the accompanying drawings.

### BRIEF DESCRIPTION OF THE DRAWINGS

FIG. 1 is a side sectional view of a torque converter, in accordance with a first embodiment of the present disclosure;

FIG. 2 is a front sectional view of the torque converter showing a stator assembly having a stator wheel mounted on a one-way clutch, in accordance with the first embodiment of the present disclosure;

FIG. 3 is an enlarged view of the one-way clutch showing multiple rollers being biased into a floating position by corresponding resilient members, in accordance with embodiments of the present disclosure;

FIG. 4 is an enlarged view of the one-way clutch showing multiple rollers in the engaged position, in accordance with embodiments of the present disclosure;

FIG. 5 is a side sectional view of the torque converter, in accordance with a second embodiment of the present disclosure;

FIG. 6 is a perspective view of the stator assembly, in accordance with the second embodiment of the present disclosure;

FIG. 7 is a side sectional view of the torque converter, in accordance with a third embodiment of the present disclosure; and

FIG. 8 is a perspective view of the stator assembly, in accordance with the third embodiment of the present disclosure.

### DETAILED DESCRIPTION

Reference numerals appearing in more than one figure indicate the same or corresponding parts in each of them. References to elements in the singular may also be construed to relate to the plural and vice-versa without limiting the scope of the disclosure to the exact number or type of such elements unless set forth explicitly in the appended claims.

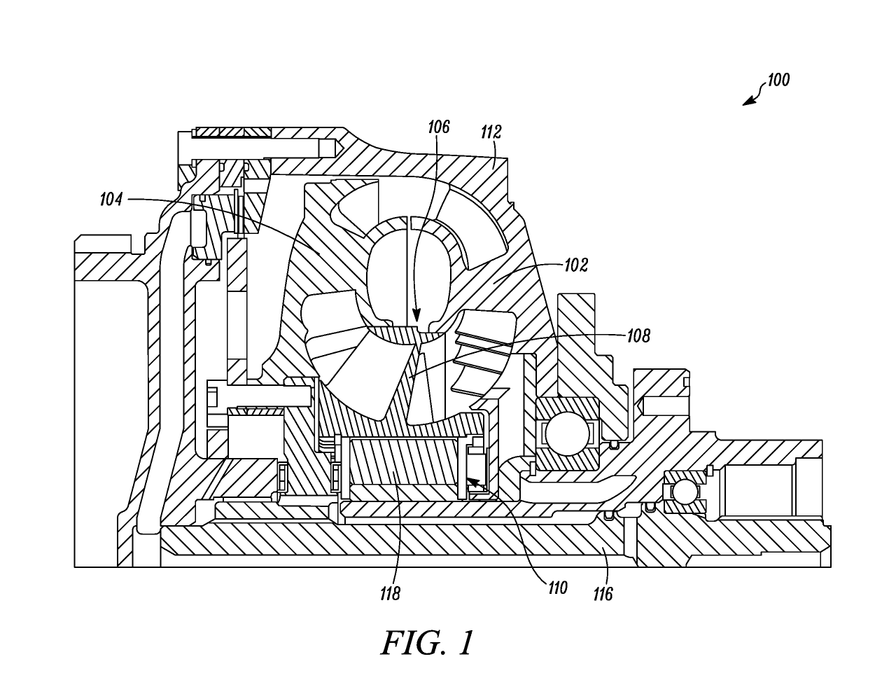

The present disclosure relates to a stator assembly 106 for controlling operation of a torque converter. FIG. 1 shows a side sectional view of a torque converter 100 in accordance with an embodiment of the present disclosure. The torque converter 100 includes an impeller 102, a turbine 104 operatively coupled to the impeller 102, and a stator assembly 106. The stator assembly 106 includes a stator wheel 108 mounted on a one-way clutch 110 and interposed between the impeller 102 and the turbine 104. Moreover, as shown, the impeller 102, the turbine 104, the stator wheel 108, and the one-way clutch 110 are disposed within a housing 112 of the torque converter 100.

Further, as shown in the illustrated embodiment of FIG. 1, the impeller 102 is formed integrally with the housing 112 of the torque converter 100. The housing 112 of the torque converter 100 may be coupled to a flexplate (not shown) of a suitable prime mover (not shown) e.g., an engine or an electric motor depending on specific requirements of an application. The turbine 104 is rigidly coupled to a transmission input shaft 116 and configured to rotate the transmission input shaft 116 for delivering drive power from the prime mover to a transmission device (not shown).

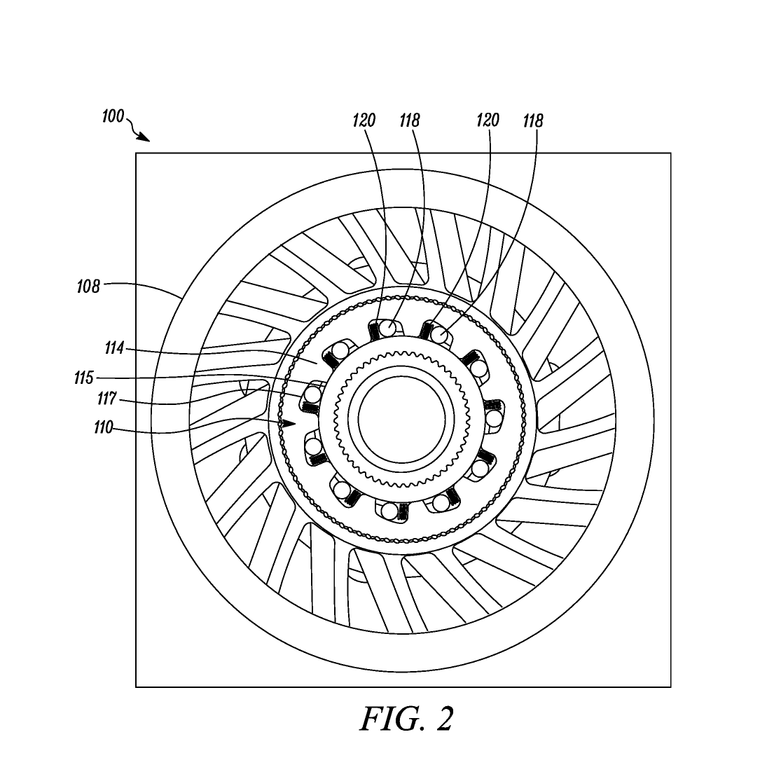

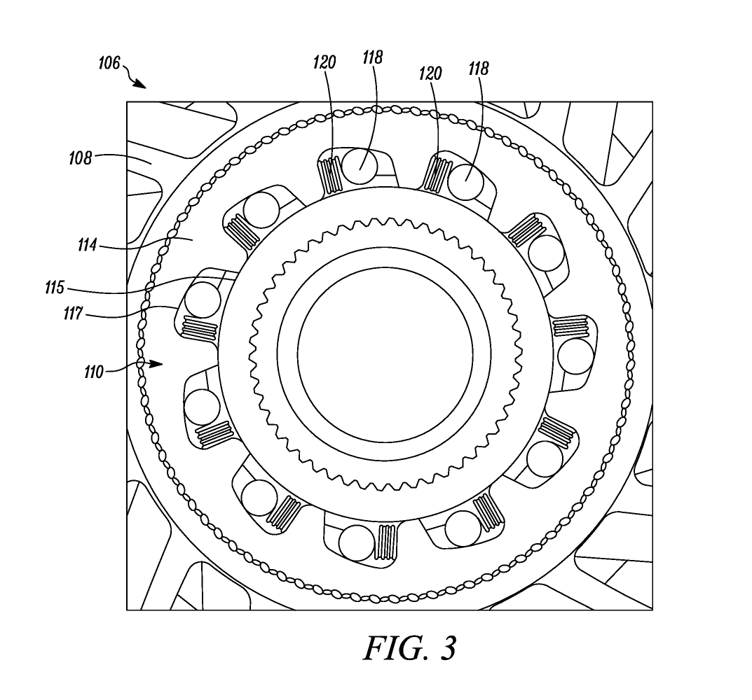

Referring to FIGS. 1 and 2, the one-way clutch 110 includes multiple rollers 118 that are arranged radially in a spaced apart relation to one another. As shown in FIG. 3, each of the rollers 118 is biased into a floating position by centripetal force from a rotational speed of the stator wheel 108 against a corresponding resilient member 120 e.g., a compression spring. As known to persons skilled in the art, the floating position of the rollers 118 can facilitate the stator wheel 108 to freewheel during a coupling mode of the torque converter 100.

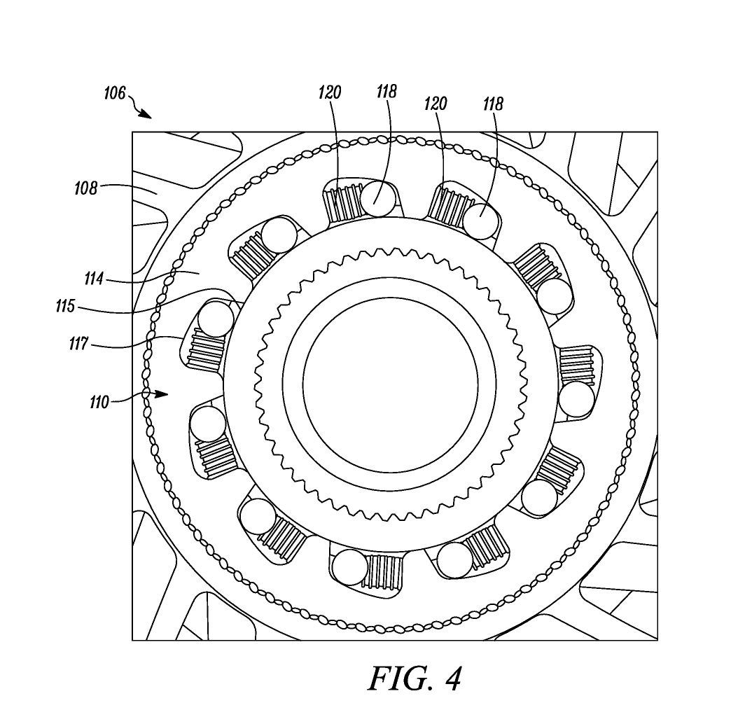

Referring to FIG. 4, each of the rollers 118 is forced away from the corresponding resilient members 120 into an engaged position. The stator wheel 108 can be held stationary by the engaged position of the individual rollers 118 in the one-way clutch 110 during a stall mode or a torque multiplication mode of the torque converter 100.

As known to persons skilled in the art, the rollers 118 have a predetermined amount of inertia and in order to cause a movement of the rollers 118 from the floating position (shown in FIG. 3) to the engaged position (shown in FIG. 4), the operating fluid forces would need to overcome the predetermined amount of inertia associated with the rollers 118 in addition to the biasing forces of the resilient members 120 while a movement of the rollers 118 from the engaged position (shown in FIG. 4) to the floating position (refer to FIG. 3) may be accomplished when the operating fluid forces accelerate the stator wheel 108 sufficiently to exceed the biasing force of the corresponding resilient member 120 i.e., when the stator wheel 108 has reached sufficient speed to generate centripetal force on the rollers 118 to oppose the bias force of the corresponding resilient members 120.

In addition to the floating and engaged positions disclosed herein, the rollers 118 of the one-way clutch 110 can also be biased into a sliding position in which the stator wheel 108 is allowed to freewheel at a rotational speed less than a pre-determined value of the rotational speed at which centripetal forces on the respective rollers 118 become sufficient enough to compress corresponding ones of the resilient members 120 and move the rollers into the floating position. A rapidity with which the one-way clutch 110 engages or disengages depends on a speed of movement associated with the rollers 118 given the amount of inertia associated with each of the rollers 118 and the biasing force of the corresponding resilient members 120.

In embodiments of this disclosure, it is contemplated that a mass of the stator wheel 108 is selected so as to operatively provide a predetermined amount of delay for engaging or disengaging the one-way clutch 110. This way, a deceleration of the stator wheel 108 occurs such that the predetermined amount of delay operatively provided by the mass of the stator wheel 108 is greater than or at least equal to a minimum amount of time required for each of the plurality of rollers 118 to move from the floating position to an engaged position.

If the minimum amount of time required for the rollers 118 of the one-way clutch 110 to move from their respective floating positions to their respective engaged positions is represented by T_{float-engage}, and the predetermined amount of delay in deceleration of the stator wheel 108 from its current operating speed to a value corresponding to the engaged positions of the respective rollers 118 is represented by D_{disengage-engage}, then D_{disengage-engage}≧T_{float-engage}. Therefore, by virtue of the mass of the stator wheel 108, a deceleration of the stator wheel 108 can be configured to provide an adequate amount of time for the rollers 118 to shift from their respective floating positions to their respective engaged positions i.e., the predetermined amount of delay in deceleration of the stator wheel 108 D_{disengage-engage} is greater than or at least equal to the minimum amount of time T_{float-engage} required by the rollers 118 to move from the floating position to an engaged position.

Further, in embodiments of this disclosure, it is also contemplated that an acceleration of the stator wheel 108 occurs such that the predetermined amount of delay operatively provided by the mass of the stator wheel 108 is greater than or at least equal to a minimum amount of time required for each of the plurality of rollers 118 to move from an engaged position to the floating position. If the minimum amount of time required for the rollers 118 of the one-way clutch 110 to move from their respective engaged positions to their respective floating positions is represented by T_{engage-float}, and the predetermined amount of delay in acceleration of the stator wheel 108 from its current operating speed to a value corresponding to a floating speed of the respective rollers 118 is represented by D_{engage-disengage}, then D_{engage-disengage}≧T_{engage-float}. Therefore, by virtue of the mass of the stator wheel 108, the acceleration of the stator wheel 108 can be reduced such that the predetermined amount of delay in acceleration of the stator wheel 108 D_{engage-disengage} is greater than or at least equal to the minimum amount of time T_{engage-float} required by the rollers 118 to move from their respective engaged positions to their respective floating positions. This way, the predetermined amount of delay D_{engage-disengage} in the acceleration of the stator wheel 108 from its current operating speed to a value corresponding to a floating speed of the respective rollers 118 provides adequate amount of time for the rollers 118 to shift from their respective engaged positions to their respective floating positions i.e., D_{engage-disengage}≧T_{engage-float}.

Furthermore, in another embodiment of this disclosure, the outer race 114 of the one-way clutch 110 includes a plurality of cam surfaces 117 as shown in FIG. 2. Each cam surface 117 is configured to establish contact with a corresponding roller 118 according to a rotational speed of the stator wheel 114. When the rotational speed of the stator wheel 108 is elevated, the rollers 118 from the one-way clutch 110 are subject to centripetal force due to which the rollers 118 are configured to compress corresponding ones of the resilient members 120. While it is possible that the resilient members 120 may have load and rate variance from one resilient member 120 to another so as to cause the resilient members 120 having low preload to be compressed more than a remainder of the resilient members 120 that have a high preload associated therewith, upon rapid engagement of the one-way clutch 108, some of the cam surfaces 117 from the outer race 114 could be biased off-center even though all the rollers 118 are in their respective engaged positions. As a result, only a remainder of the cam surfaces 117 from the outer race 114 of the one-way clutch 110 would be able to take up load against the corresponding rollers 118 on the opposing side. However, with implementation of embodiments disclosed herein, a mass of the stator wheel 108 so selected beneficially causes the corresponding inertia of the stator wheel 108 to allow each of the cam surfaces 117 to center with the corresponding rollers 118 prior to engagement with the rollers 118. This way, it is envisioned that the mass and corresponding inertia of the stator wheel 108 provide sufficient amount of time to allow an increased number of rollers 118 to appropriately center with the corresponding cam surfaces 117 of the outer race 114 and consistently take up the load upon engagement.

In embodiments of this disclosure, the stator wheel 108 can be formed from one of a ferrous material e.g., cast iron, steel etc., or a non-ferrous material e.g., aluminum, bronze, or other materials commonly known in the art. Although non-ferrous materials such as aluminum and bronze are disclosed herein, a type of material used to form the stator wheel 108, and therefore impart mass to the stator wheel 108 for reducing the acceleration and deceleration of the stator wheel 108, may vary from one application to another depending on specific requirements of an application.

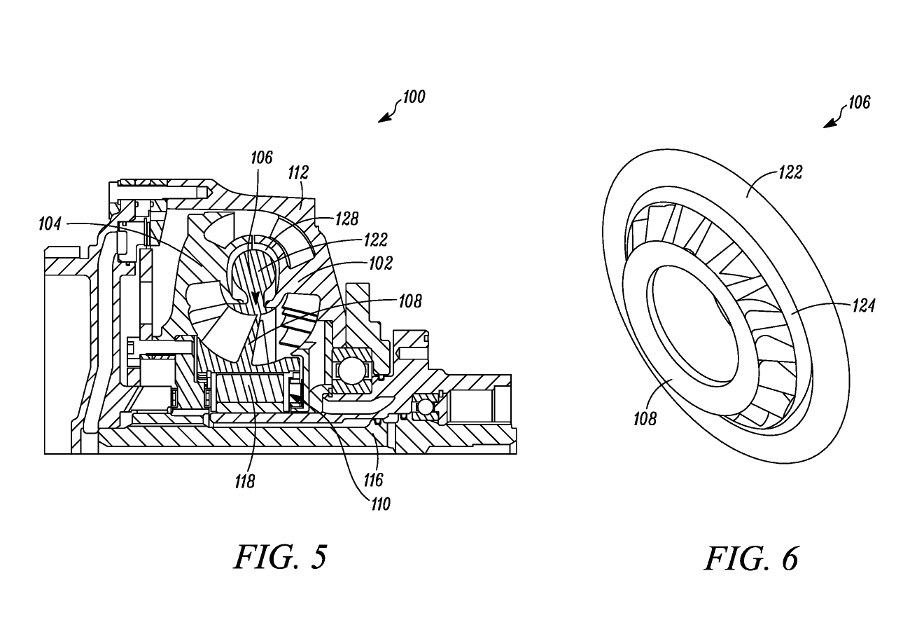

In another embodiment as shown in FIGS. 5-6, the stator wheel 108 is provided with a ring 122 disposed on an outer circumference 124 of the stator wheel 108. The ring 122 is configured to increase an amount of inertia associated with the stator wheel 108. It will be acknowledged that an amount of increase in the inertia of the stator assembly 106 is now dependent i.e., proportional to the mass of the stator wheel 108 and the added mass of the ring 122. Moreover, as shown in FIG. 5, the ring 122 is configured to advantageously protrude into an annular region 128 defined between the impeller 102 and the turbine 104 of the torque converter 100. This way, the ring 122 can be conveniently accommodated within the annular region 128 defined between the impeller 102 and the turbine 104.

Moreover, as shown in the illustrated embodiment of FIGS. 5-6, the ring 122 may be integrally formed with the stator wheel 108. It can be contemplated by way of embodiments herein to form the stator wheel 108 and the ring 122 from similar or dissimilar materials. In an example where dissimilar materials are used, the stator wheel 108 may be formed from aluminum while the ring 122 may be formed from cast iron. In another example, both the stator wheel 108 and the ring 122 may be formed from cast iron. It can also be contemplated to form the ring 122 using a material having a higher density compared to that of the stator wheel 108. Therefore, it will be appreciated that various materials can be advantageously used to form the stator wheel 108 and the ring 122 to meet specific requirements of an application.

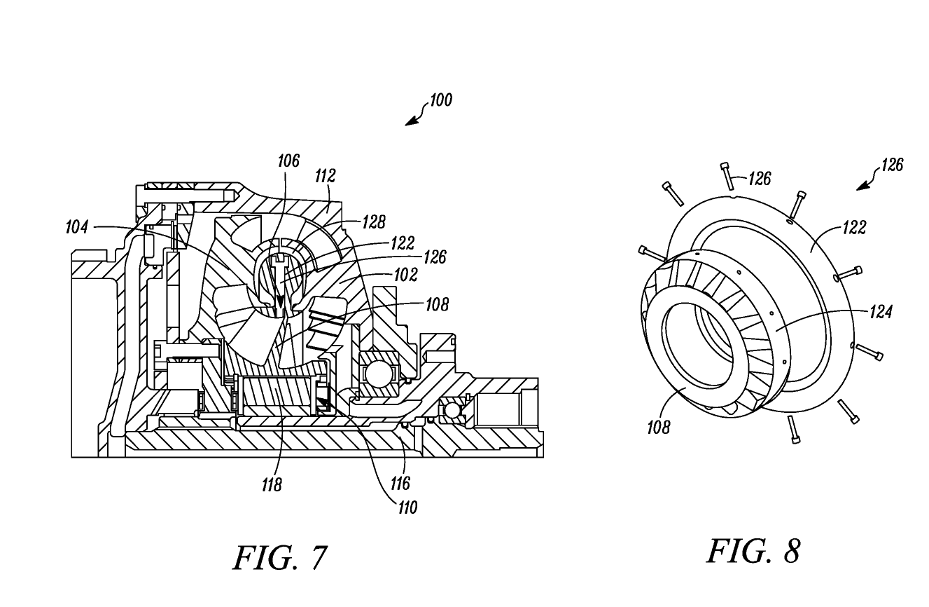

In yet another embodiment, the ring 122 may be coupled to the stator wheel 108 by using at least one of bolting, welding, keying, a retaining mechanism, an interference fit, and a threaded fit. As shown in the illustrated embodiment of FIGS. 7-8, the ring 122 and the stator wheel 108 are formed independently of one another and are mutually coupled with the help of bolts 126. Moreover, similar to the preceding embodiment of FIG. 5, the ring 122 in this embodiment can also be configured to advantageously protrude within the annular region 128 defined between the impeller 102 and the turbine 104 as shown in FIG. 7.

In the embodiments of FIGS. 5-6 and FIGS. 7-8, the ring 122 is configured to increase an amount of inertia associated with the stator wheel 108 so that acceleration and deceleration of the stator wheel 108 may be reduced to a value that allows sufficient time for the rollers 118 of the one-way clutch 110 to execute movement between their respective engaged and floating positions or vice-versa. With use of the embodiments disclosed in conjunction with FIGS. 5-6 and FIGS. 7-8, persons skilled in the art can also beneficially vary the amount of predetermined delay to provide for the minimum amount of time required by the rollers 118 to shift from their respective floating positions to their respective engaged positions and vice-versa i.e., D_{disengage-engage}≧T_{float-engage} and D_{engage-disengage}≧T_{engage-float}.

In embodiments of this disclosure, although it has been contemplated to increase the inertia of the stator assembly wheel 106 by increasing a mass of the stator wheel 108 and/or by providing the ring 122 to the stator wheel 108, it can also be contemplated to change or alter a section geometry of the stator wheel 108 e.g., by adding mass at locations other than at the outer circumference 124 of the stator wheel 108 disclosed herein such that an inertia associated with the stator wheel 108 is configured to provide adequate time for the rollers 118 to perform functions consistent with this disclosure. Therefore, although embodiments herein are directed to the ring 122 at the outer circumference 124 of the stator wheel 108, it will be appreciated that various methods of increasing an inertia of the stator wheel 108 can be contemplated by persons skilled in the art without deviating from the spirit of the present disclosure.

Moreover, although some components typically present in conventionally known torque converters have been omitted from the configuration of the torque converter 100 disclosed herein for the sake of simplicity and convenience in understanding the present disclosure, it may be noted that embodiments of the present disclosure are not limited to the specific configuration of the torque converter 100 disclosed herein. In fact, it will be appreciated by persons skilled in the art that embodiments of the present disclosure can be similarly applied in various other configurations of torque converters having one or more additional components including, but not limited to, a lock-up clutch, an impeller clutch, a torque divider, and/or a stator clutch which by way of example is described in U.S. Pat. No. 8,939,859.

Further, persons skilled in the art will recognize that a configuration of the one-way clutch 110 described in this document is only one of many possible configurations known in the art for accomplishing the locked, transition and freewheel modes of operation. Therefore, it may be noted that a specific configuration of the one-way clutch disclosed herein is non-limiting of this disclosure. Rather, it will be appreciated by persons skilled in the art that embodiments disclosed herein may be similarly applied to numerous other configurations of one-way clutches known in the art without deviating from the spirit of the present disclosure.

Various embodiments disclosed herein are to be taken in the illustrative and explanatory sense, and should in no way be construed as limiting of the present disclosure. All joinder references (e.g., attached, affixed, coupled, engaged, meshed, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to or over another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for use and implementation in controlling an operation of a torque converter. With use of previously known torque converters, a rapidity in the movement of rollers associated with a one-way clutch was known to cause premature fatigue and/or failure of the rollers. With use of embodiments disclosed herein, manufacturers can prolong a service life of the rollers in the one-way clutch while continuing to accomplish a smooth shift of drive power from the prime mover to the transmission input shaft.

Moreover, embodiments disclosed in conjunction with FIGS. 5-6 and FIGS. 7-8 can be used to conveniently retro-fit the ring 122 to an existing stator wheel of a given torque converter for increasing the inertia of the stator assembly and hence, reducing the acceleration and deceleration of the stator assembly. Reduction in the acceleration and deceleration of the stator assembly provides sufficient amount of time for the rollers to shift from their current positions into their respective engaged or floating positions as required. As the rollers 118 can now shift into their respective engaged or floating positions in the sufficient amount of time provided by the predetermined amount of delay i.e., D_{disengage-engage} or D_{engage-disengage}, a rapidity in the movement of the rollers can be mitigated to help reduce fatigue and/or failure of the one-way clutch. Further, a service life of the rollers in the one-way clutch may be improved with use of embodiments disclosed herein.

Also, the ring 122, as disclosed in the embodiments of FIGS. 5-6 and FIGS. 7-8, can be accommodated within an annular region typically defined between the impeller and the turbine, manufacturers may entail little or no additional modifications to an existing torque converter during the installation of the stator assembly 106 disclosed herein.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A stator assembly for a torque converter having an impeller and a turbine, the stator assembly comprising:
a one-way clutch comprising a plurality of rollers arranged radially in a spaced apart relation to one another, each of the plurality of rollers being biased into a floating position by a corresponding resilient member; and
a stator wheel mounted on the one-way clutch, wherein a mass of the stator wheel is selected to operatively provide a predetermined amount of delay for engaging or disengaging the one-way clutch.

2. The stator assembly of claim 1, wherein a deceleration of the stator wheel occurs such that the predetermined amount of delay operatively provided by the mass of the stator wheel is greater than or at least equal to a minimum amount of time required for each of the plurality of rollers to move from the floating position to an engaged position.

3. The stator assembly of claim 1, wherein an acceleration of the stator wheel occurs such that the predetermined amount of delay operatively provided by the mass of the stator wheel is greater than or at least equal to a minimum amount of time required for each of the plurality of rollers to move from an engaged position to the floating position.

4. The stator assembly of claim 1, wherein the stator wheel is provided with a ring disposed on an outer circumference of the stator wheel, the ring being configured to increase an amount of inertia associated with the stator assembly.

5. The stator assembly of claim 4, wherein the ring is configured to protrude into an annular region defined between the impeller and the turbine of the torque converter.

6. The stator assembly of claim 4, wherein the ring is configured to reduce the deceleration of the stator wheel such that the predetermined amount of delay is greater than or at least equal to a minimum amount of time required for each of the plurality of rollers to move from the floating position to an engaged position.

7. The stator assembly of claim 4, wherein the ring is configured to reduce the acceleration of the stator wheel such that the predetermined amount of delay is greater than or at least equal to a minimum amount of time required for each of the plurality of rollers to move from an engaged position to the floating position.

8. The stator assembly of claim 4, wherein the stator wheel and the ring are formed using one of: similar materials and dissimilar materials.

9. The stator assembly of claim 4, wherein the ring is formed using one of:
aluminum, bronze, and a ferrous material.

10. The stator assembly of claim 4, wherein the ring is formed from a material having a higher density compared to a material used to form the stator wheel.

11. The stator assembly of claim 4, wherein the ring is formed integrally with the stator wheel.

12. The stator assembly of claim 4, wherein the ring is coupled to the stator wheel by at least one of: bolting, welding, keying, a retaining mechanism, an interference fit, and a threaded fit.

13. The stator assembly of claim 1, wherein the stator wheel is formed using one of: a ferrous material and a non-ferrous material.

14. A torque converter comprising:
an impeller;
a turbine operatively coupled to the impeller; and
a stator wheel mounted on a one-way clutch and interposed between the impeller and the turbine, the one-way clutch having a plurality of rollers arranged radially in a spaced apart relation to one another, each of the plurality of rollers being biased into a floating position by a corresponding resilient member, wherein a mass of the stator wheel is selected to operatively provide a predetermined amount of delay for engaging or disengaging the one-way clutch.

15. The torque converter of claim 14, wherein a deceleration of the stator wheel occurs such that the predetermined amount of delay operatively provided by the mass of the stator wheel is greater than or at least equal to a minimum amount of time required for each of the plurality of rollers to move from the floating position to an engaged position.

16. The torque converter of claim 14, wherein an acceleration of the stator wheel occurs such that the predetermined amount of delay operatively provided by the mass of the stator wheel is greater than or at least equal to a minimum amount of time required for each of the plurality of rollers to move from an engaged position to the floating position

17. The torque converter of claim 14, wherein the stator wheel is provided with a ring disposed on an outer circumference of the stator wheel, the ring being configured to increase an amount of inertia associated with the stator assembly.

18. The torque converter of claim 17, wherein the ring is configured to protrude into an annular region defined between the impeller and the turbine of the torque converter.

19. The torque converter of claim 17, wherein the ring is configured to reduce the deceleration of the stator wheel such that the predetermined amount of delay is at least equal to or greater than a minimum amount of time required for each of the plurality of rollers to move from the floating position to an engaged position.

20. The torque converter of claim 17, wherein the ring is configured to reduce the acceleration of the stator wheel such that the predetermined amount of delay is at least equal to or greater than a minimum amount of time required for each of the plurality of rollers to move from an engaged position to the floating position.
